(19) United States
(12) Patent Application Publication
(10) Pub. No.: US 2020/0158556 A1
(43) Pub. Date: May 21, 2020

(54) POWER MANAGEMENT

(71) Applicant: Elliptic Laboratories AS, Oslo (NO)

(72) Inventors: Guenael Thomas STRUTT, San Francisco, CA (US); Espen KLOVNING, Strommen (NO)

(73) Assignee: Elliptic Laboratories AS, Oslo (NO)

(21) Appl. No.: 16/687,943

(22) Filed: Nov. 19, 2019

Related U.S. Application Data
(60) Provisional application No. 62/770,710, filed on Nov. 21, 2018.

(30) Foreign Application Priority Data
Dec. 19, 2018 (NO) 20181651

(51) Int. Cl. G01F 23/296; G06F 16/9035; G01S 15/10; G06F 1/3203

(52) U.S. Cl. CPC G01F 23/2962; G06F 1/3203; G01S 15/10; G06F 16/9035

(57) ABSTRACT

Present teachings relate to a method for determining the proximity of an object to an electronic device, the electronic device comprising an ultrasonic sensor and a second sensor, which ultrasonic sensor comprising at least one ultrasonic transmitter and at least one ultrasonic receiver, which method comprising the steps of:
transmitting from the ultrasonic transmitter an ultrasonic signal;
receiving at the ultrasonic receiver an ultrasonic response signal;
determining an ultrasonic response by processing the ultrasonic response signal using a processor;
determining a sensor response by processing a second signal using a processor, said second signal being generated by the second sensor;
configuring via the processor a power level of a second ultrasonic signal transmitted from the ultrasonic transmitter in response to the ultrasonic response meeting a first criterion, and the sensor response meeting a second criterion.

The present teachings further relate to an electronic device configured to execute the method steps and to a computer software product.

### CROSS-REFERENCE TO RELATED APPLICATIONS

This patent application claims the benefit of U.S. Provisional Patent Application No. 62/770,710, filed on Nov. 21, 2018. The entire contents of U.S. Provisional Patent Application No. 62/770,710 is incorporated herein by reference in its entirety.

### TECHNICAL FIELD

The present teachings relate to an electronic device that is suitable for touchless interaction.

### BACKGROUND ART

Several electronic devices available in the market today allow a user to interact with the device using a touch-based interface, such as a touchscreen. The touch-based interface is used for capturing the user's input through touch on a touch sensitive surface. There also exist touchless interfaces for electronic devices that allow the user to interact with the device in a touchless manner.

In handheld electronic devices such as mobile phones, the touchless interface may be used to detect proximity of the user or the user's body part, while in some cases the touchless interface may further be used to detect gestures performed by the user.

Ultrasonic touchless technology is an example of the technology used in touchless interfaces. Ultrasonic technology in some cases is used as a replacement for the infrared (“IR”) sensor that is used for proximity detection, for example, in smart phones. Often, an ultrasonic touchless interface can provide more functionality than a common IR sensor such that it can be more advantageous to replace the IR sensor with the ultrasonic sensor. One drawback of the ultrasonic touchless interface can be that it can have a higher power consumption as compared to a typical IR sensor.

WO2012172322 by the same applicant disclosed a portable electronic device in which touchless interaction mode may be turned on and off, and the device is configured to execute an additional operation when the touchless interaction mode is turned off.

There is hence a requirement of an ultrasonic touchless interface for proximity detection that can provide a reduced power consumption.

### SUMMARY

At least some problems inherent to the prior-art will be shown solved by the features of the accompanying independent claims.

When viewed from a first perspective, there can be provided a method for determining the proximity of an object to an electronic device, the electronic device comprising an ultrasonic sensor and a second sensor, which ultrasonic sensor comprising at least one ultrasonic transmitter and at least one ultrasonic receiver, which method comprising the steps of:
transmitting from the ultrasonic transmitter an ultrasonic signal;
receiving at the ultrasonic receiver an ultrasonic response signal;
determining an ultrasonic response by processing the ultrasonic response signal using a processor;
determining a sensor response by processing a second signal using a processor, said second signal being generated by the second sensor;
configuring via the processor a power level of a second ultrasonic signal transmitted from the ultrasonic transmitter in response to the ultrasonic response meeting a first criterion, and the sensor response meeting a second criterion.

It will be clear that said second ultrasonic signal is transmitted subsequent to the first ultrasonic signal.

According to an aspect there can also be provided an electronic device, the electronic device comprising an ultrasonic sensor and a second sensor, which ultrasonic sensor comprising at least one ultrasonic transmitter and at least one ultrasonic receiver, wherein the electronic device is configured to:
transmit an ultrasonic signal from the ultrasonic transmitter;
receive an ultrasonic response signal at the ultrasonic receiver;
determine via a processor an ultrasonic response by processing the ultrasonic response signal; and
determine via the processor a sensor response by processing a second signal generated by the second sensor; wherein
   the electronic device is configured to adapt a power level of a second ultrasonic signal transmitted from the ultrasonic transmitter in response to the ultrasonic response meeting a first criterion, and the sensor response meeting a second criterion.

The power level may be adapted via the processor, or through another module or processing unit of the electronic device.

According to yet another aspect, there can also be provided a computer software product, and a carrier bearing the same, which, when executed on a processing means, causes the processing means to:
transmit an ultrasonic signal from an ultrasonic transmitter;
receive an ultrasonic response signal at an ultrasonic receiver;
determine via a processor an ultrasonic response by processing the ultrasonic response signal; and
determine via the processor a sensor response by processing a second signal generated by the second sensor; and
configure a power level of a second ultrasonic signal transmitted from the ultrasonic transmitter in response to the ultrasonic response meeting a first criterion, and the sensor response meeting a second criterion.

The processing means may either be the same component as the processor, or alternatively the processing means may comprise the processor.

Any of the responses may be obtained either by processing the corresponding signals continuously or periodically. Moreover, periods may be regular or irregular. Similarly, the responses meeting their corresponding criteria may also be done continuously or periodically, irrespective of how the processing of the signals is performed.

It will be understood that according to an aspect, the method may even be described as; a method for determining the proximity of an object to an electronic device, the electronic device comprising an ultrasonic sensor and a second sensor, which ultrasonic sensor comprising at least one ultrasonic transmitter and at least one ultrasonic receiver, which method comprising the steps of:
transmitting from the ultrasonic transmitter an ultrasonic signal;
receiving at the ultrasonic receiver an ultrasonic response signal;
determining an ultrasonic response by processing the ultrasonic response signal using a processor;
determining a sensor response by processing a second signal using a processor, said second signal being generated by the second sensor;
controlling via the processor the transmitting of a second ultrasonic signal from the ultrasonic transmitter in response to the ultrasonic response meeting a first criterion, and the sensor response meeting a second criterion.

Similarly the electronic device may be generally described as; an electronic device, the electronic device comprising an ultrasonic sensor and a second sensor, which ultrasonic sensor comprising at least one ultrasonic transmitter and at least one ultrasonic receiver, wherein the electronic device is configured to:
transmit an ultrasonic signal from the ultrasonic transmitter;
receive an ultrasonic response signal at the ultrasonic receiver;
determine via a processor an ultrasonic response by processing the ultrasonic response signal; and
determine via the processor a sensor response by processing a second signal generated by the second sensor; wherein
   the electronic device is configured to control the transmission of a second ultrasonic signal from the ultrasonic transmitter in response to the ultrasonic response meeting a first criterion, and the sensor response meeting a second criterion.

Also similarly, the software product may be generally described as; a computer software product, and a carrier bearing the same, which, when executed on a processing means, causes the processing means to:
transmit an ultrasonic signal from an ultrasonic transmitter;
receive an ultrasonic response signal at an ultrasonic receiver;
determine via a processor an ultrasonic response by processing the ultrasonic response signal; and
determine via the processor a sensor response by processing a second signal generated by the second sensor; and
control the transmission of a second ultrasonic signal from the ultrasonic transmitter in response to the ultrasonic response meeting a first criterion, and the sensor response meeting a second criterion.

According to an aspect, the first criterion is chosen from a plurality of first criteria, or from a first criterion.

According to further an aspect, the second criterion is chosen from a plurality of second criteria, or from a second criterion.

Accordingly, when viewed from a second perspective, there can also be provided a method for determining proximity of an object to an electronic device, the electronic device comprising an ultrasonic sensor and a second sensor, which ultrasonic sensor comprising at least one ultrasonic transmitter and at least one ultrasonic receiver, which method comprising the steps of:
transmitting from the ultrasonic transmitter an ultrasonic signal;
receiving at the ultrasonic receiver an ultrasonic response signal;
determining an ultrasonic response by processing the ultrasonic response signal using a processor;
determining a sensor response by processing a second signal using a processor, said second signal being generated by the second sensor;
configuring via the processor a power level of a second ultrasonic signal transmitted from the ultrasonic transmitter in response to the ultrasonic response meeting a first criterion, and the sensor response meeting a second criterion; wherein the first criterion belongs to a plurality of first criteria, and the second criterion belongs to a plurality of second criteria.

Similarly, according to an aspect there can also be provided an electronic device, the electronic device comprising an ultrasonic sensor and a second sensor, which ultrasonic sensor comprising at least one ultrasonic transmitter and at least one ultrasonic receiver, which the electronic device is configured to:
transmit an ultrasonic signal from the ultrasonic transmitter;
receive an ultrasonic response signal at the ultrasonic receiver;
determine via a processor an ultrasonic response by processing the ultrasonic response signal;
determine via the processor a sensor response by processing a second signal generated by the second sensor; wherein
   the electronic device is configured to adapt a power level of a second ultrasonic signal transmitted from the ultrasonic transmitter in response to the ultrasonic response meeting a first criterion, and the sensor response meeting a second criterion, wherein the first criterion belongs to a plurality of first criteria, and the second criterion belongs to a plurality of second criteria.

According to yet another aspect, there can also be provided a computer software product, and a carrier bearing the same, which, when executed on a processing means, causes the processing means to:
transmit an ultrasonic signal from the ultrasonic transmitter;
receive an ultrasonic response signal at the ultrasonic receiver;
determine via a processor an ultrasonic response by processing the ultrasonic response signal;
determine via the processor a sensor response by processing a second signal generated by the second sensor; and
configure a power level of a second ultrasonic signal transmitted from the ultrasonic transmitter in response to the ultrasonic response meeting a first criterion, and the sensor response meeting a second criterion, wherein the first criterion belongs to a plurality of first criteria, and the second criterion belongs to a plurality of second criteria.

Throughout this disclosure, it will be understood that the ultrasonic signal may comprise either a single frequency or a plurality of frequencies. In some cases, the ultrasonic signal may comprise chirps.

Moreover, the processing of the ultrasonic response may be based on time of flight (“TOF”) measurements between the ultrasonic signal and the corresponding ultrasonic response. In most cases, the ultrasonic response may also be termed as an echo or an echo signal. The processing of the echo signal may also be based on determining the amplitude of the echo signal, usually with respect to the amplitude of the ultrasonic signal, or it may be based upon determining the phase difference between the ultrasonic signal and the echo signal, or the frequency difference between the ultrasonic signal and the echo signal, or any combination thereof.

Additionally, in this disclosure, references to an ultrasonic transmitter and an ultrasonic receiver are intended to cover all functioning alternatives of what may collectively be termed as an ultrasonic sensor. The ultrasonic sensor may be such that the ultrasonic transmitter and the ultrasonic receiver are separate devices, or it may be such that both the ultrasonic transmitter and the ultrasonic receiver are the same device. In the latter case, the ultrasonic sensor may be configured to operate as a transmitter for transmitting the ultrasonic signal in a transmit mode, and the same ultrasonic sensor may be configured to operate as the ultrasonic receiver for receiving the ultrasonic response. The ultrasonic sensor may even be a combination of any available ultrasonic transmitters that are functionally related to the electronic device and any available ultrasonic receivers functionally related to the electronic device. Accordingly, the ultrasonic sensor may even comprise a plurality of ultrasonic sensors. Or even, the term ultrasonic transmitter is also intended to encompass a plurality of transmitters. Similarly, the term ultrasonic receiver is also intended to encompass a plurality of receivers. The ultrasonic receivers may be equal to the number of ultrasonic transmitters, or they may be unequal numbers. As the skilled person will appreciate, one or more loudspeakers, piezo actuators, and microphones of the electronic device that are used for audio functionality can also be leveraged for ultrasonic measurements, hence obviating the requirement for dedicated ultrasonic sensor(s). In such cases, for example, it is not uncommon to have an unequal number of loudspeakers as compared to the number of microphones. It will be understood that the loudspeaker may be used as an ultrasonic transmitter whereas the microphone may be used as an ultrasonic receiver. The number of transmitters and/or receivers is non-limiting to the scope or generality of this disclosure.

It will further be appreciated that in cases where the ultrasonic transmitter and the ultrasonic receiver are separate components, they may be placed in the same location, or they may be installed at different locations on the electronic device. Furthermore, as previously explained the electronic device may comprise a plurality of ultrasonic transmitters and/or a plurality of ultrasonic receivers. Multiple ultrasonic transmitter-receiver combinations may be used for extracting spatial information related to the object and/or surroundings.

Reverting to the method, the electronic device, and the software product, according to another aspect, the first criterion and/or the second criterion is a threshold value or a pattern. Accordingly, the first criterion is a threshold value and/or a pattern associated with the ultrasonic response or the ultrasonic response signal. Similarly, the second criterion may be a threshold value and/or a pattern associated with the sensor response or the second signal.

Similarly, the plurality of first criterion may comprise respective threshold values and/or patterns of the ultrasonic response.

A threshold and/or pattern of ultrasonic response may be understood, for example, as a comparative evaluation performed by the processor such that if the ultrasonic response meets at least one criterion, it leads the processor to conclude that the state of the electronic device has been changed such that the power level of the second ultrasonic signal may be configured accordingly.

Hence in other words, the plurality of first criteria comprise a respective threshold and/or pattern of the ultrasonic response, each of said threshold and/or pattern of ultrasonic response being associated with a state of the electronic device such that the power level of the second ultrasonic signal is configured according to the state of the electronic device determined by comparing the ultrasonic response with at least one of the criteria from the plurality of first criterion. As previously stated, the comparing of the ultrasonic response with at least one of the criteria is done using the processor.

Following the above, similarly, the plurality of second criterion may comprise respective thresholds and/or patterns of the sensor response. A threshold and/or pattern of the sensor response may be understood, for example, as a comparative evaluation performed by the processor such that if the sensor response meets at least one criterion, it leads the processor to conclude that the state of the electronic device has been changed such that the power level of the second ultrasonic signal may be configured accordingly. Accordingly, the plurality of second criteria comprise a respective threshold value and/or pattern of the second signals, each of said threshold and/or pattern of the second signal being associated with a state of the electronic device such that the power level of the second ultrasonic signal is configured according to the state of the electronic device determined by comparing the second signal with at least one of the criteria from the plurality of second criteria. As previously stated, the comparing of the sensor response with at least one of the criteria is done using the processor.

As it will be understood from the above, in some cases, it may be sufficient to configure the power level of the second ultrasonic signal by determining the state of the electronic device by comparing the ultrasonic response with at least one of the criteria from the plurality of first criteria. In other words, the determination of the state of the electronic device further by comparing the sensor response with at least one of the criteria from the plurality of second criteria might not be necessary. In such cases, either the sensor response is not evaluated, or it may be ignored. Accordingly, the first criterion overrides the second criteria such that the power level of the second ultrasonic signal is configured in response to the ultrasonic response meeting the first criterion. As it will be appreciated, by doing so, at least the power consumption and/or the processing power associated with processing the sensor response can be reduced.

While in other cases, the determination of the state of the electronic device processing the sensor response may be used to further confirm the state determined by comparing the ultrasonic response with at least one of the criteria.

Similarly, in some cases, it may be sufficient to configure the power level of the second ultrasonic signal by determining the state of the electronic device by comparing the sensor response with at least one of the criteria from the plurality of second criterion. In other words, the determination of the state of the electronic device further by comparing the ultrasonic response with at least one of the criteria from the plurality of first criterion might not be necessary. In such cases, the either the ultrasonic response is not evaluated, or it may be ignored. Accordingly, the second criterion overrides the first criterion such that the power level of the second ultrasonic signal is configured in response to the sensor response meeting the second criterion. As it will be appreciated, by doing so, at least the power consumption associated with transmitting the second ultrasonic signal and/or the processing power associated with processing the ultrasonic response signal can be reduced.

While in other cases, the determination of the state of the electronic device processing the ultrasonic response may be used to further confirm the state determined by the sensor response.

In some cases, it may be possible that neither the ultrasonic response, nor the sensor response is enough individually to determine the state of the electronic device. In such cases, the processor is configured to correlate the sensor response with the ultrasonic response for determining the state of the electronic device. This may, for example, be done by comparing the ultrasonic response and the sensor response with at least one of the criteria from a plurality of third criteria. The plurality of third criteria may comprise at least a portion of the plurality of first criteria and at least a portion the plurality of second criteria. Additionally, or alternatively, the plurality of third criteria may comprise criteria different from the first and/or the second criterion.

The second sensor is a non-ultrasonic sensor. Moreover, the second sensor may comprise a plurality of non-ultrasonic sensors. The second sensor may be any one or more of the: capacitive touchscreen sensor, accelerometer, gyroscope, electromagnetic radiation sensor—such as IR, camera, fingerprint sensor—magnetic sensor, Hall sensor, or any other sensors that are available in the electronic device that can provide any information related to a state of the device. Some of the mentioned sensors are included in what is sometimes known as the Inertial Measurement Unit (“IMU”) sensors.

According to an aspect, when the second sensor is the touchscreen sensor of the electronic device, and when the touchscreen sensor is providing such sensor response that indicates that the user is interacting with the device through touch, the sensor response is used to configure the power level of the second ultrasonic signal.

It will be appreciated that the second signal being a touchscreen signal, said touchscreen signal may be obtained from any mode of operation of the touchscreen, e.g., it may be obtained from what is known as the mutual-capacitance operation mode, or from the self-capacitance operation mode. The self-capacitance mode can generally detect objects farther away, from the touchscreen surface, as compared to the mutual capacitance mode. The self-capacitance mode is often more suitable for measurements such as hover detection of a finger or even a cheek of the user. Accordingly, the power level of the second ultrasound signal may be adjusted in response to the touchscreen signal reporting an object in contact with, or in close proximity to, the screen of the device.

Preferably, the power level of the second ultrasonic signal is reduced for reducing the overall power consumption of the device. The sensor response may be measured either through the touchscreen sensor directly, or through another module that indicates that touchscreen in active and/or touch data is being processed by the electronic device. Similarly, the power level of a subsequent ultrasonic signal may be increased in response to the touchscreen being switched-off or not being actively used.

As previously discussed, in some cases when the touchscreen response is insufficient to determine what the use case or state of the electronic device is, the processor may correlate the touchscreen response with the ultrasonic response from the ultrasonic response signal to configure the power level of the second ultrasonic signal. An example of such a state may be “bag-mode” wherein the electronic device is placed in a bag. Typically, in such cases, the ultrasonic response will comprise a plurality of strong echoes that will be insufficient to determine what kind of object is causing them. The touchscreen sensor will typically provide a weak response due to the device being placed in an isolated environment such as the interior of a bag without any large capacitive load touching the screen. Thus, by combining the ultrasonic response with the touchscreen response, either threshold-wise or by comparing the pattern thereof, more information may be obtained about the state of the device. As a further example, if the one or more signals from one or more other sensors are combined, the determination of the state may further be improved. For example, the sensor signal from a light sensor may indicate that the device is in a relatively dark space. Additionally, signal(s) from IMU may provide a sensor response that indicates that the device is in movement. Accordingly, it may be concluded by the processor by correlating the ultrasonic response with the sensor response that the electronic device is being carried in a bag. Since in such a case there is usually no requirement for an active ultrasonic measurement, the power of the second ultrasonic signal may either be reduced or even switched off.

It will be understood that by saying configuring the power of the second ultrasonic signal, or by saying controlling the transmission of the second signal, it is intended to cover any way the overall power of the transmitted signal can be changed. It may be done, for example, by any one or more of: altering the amplitude of the second ultrasonic signal with respect to the ultrasonic signal, changing the frequency of the second ultrasonic signal, or if the second ultrasonic signal comprises a series of signals or chirps, even changing the duty cycle of the second ultrasonic signal. Furthermore, delaying the transmission of the second ultrasonic signal, or even switching off or preventing the second ultrasonic signal from being transmitted lie within the ambit of the terms.

According to an aspect, the ultrasonic response signal is used for proximity detection i.e., to detect proximity of an object. The object can be a body part of the user, such as the head, a hand, or even a finger of the user. The proximity detection is used for establishing a state of the electronic device. For example, the proximity detection can result in establishing that the electronic device is in a proximity state, which is a near state. The near state can imply that a user or a body part of the user is located at or closer than a predetermined near distance from the electronic device. Alternatively to the near state, the proximity detection may establish that the electronic device is in a proximity state that is a far state. The far state can imply that the user is located at or beyond a far distance from the electronic device.

According to yet another aspect, the power of the second ultrasonic signal is reduced when the proximity state determined from the ultrasonic response signal indicates that the electronic device is in the near state and the touchscreen sensor response indicates an object is in close proximity to or in contact with the touchscreen and that object is relatively static. By relativity static it is meant here that the touchscreen response indicates the object has been in close proximity to or in contact with essentially the same area of the screen beyond a given time period from the point when the proximity of the object was initially detected. It will be appreciated that such a combination of ultrasonic and touchscreen responses may indicate that the electronic device is being held against a cheek of the user. In such a case, the second ultrasonic signal may be transmitted with a substantially reduced power as compared to the ultrasonic signal. In some cases, the second ultrasonic signal may be switched off altogether, or a transmission of the second ultrasonic signal postponed until the touchscreen response changes.

It will be appreciated that instead of or in addition to the touchscreen, another capacitive sensor may be used, if such a sensor is available in the electronic device and can provide a signal indicative of a relevant state of the electronic device.

According to yet another aspect, the power of the second ultrasonic signal is reduced when a proximity state determined by using the ultrasonic response signal indicates that the electronic device is in the near state and the response of one or more signals from the IMU indicates that the electronic device is relatively static or stationery. The electronic device may thus determine using a combination of ultrasonic and IMU response the position in which the electronic device is placed. For example, it may determine that the electronic device is being held by the user. In such a case, the second ultrasonic signal may be transmitted with a substantially reduced power as compared to the ultrasonic signal. In some cases, the second ultrasonic signal may be switched off altogether, or a transmission of the second ultrasonic signal postponed until the IMU response changes. Such a determination made by using the ultrasonic and IMU responses is novel and inventive in its own right.

According to further an aspect, at least a part of a previous IMU response, e.g., a movement detected by the IMU prior to the determining that the electronic device is relatively static, is used to determine the position in which the electronic device is placed. For example, when the user picks up the electronic device for making a call, the IMU may register a typical movement or a set of movements that can be associated with bringing the electronic device close to the user's ear. This can further improve the detection of the state of the electronic device. Moreover, the touchscreen response and IMU response may be used in combination as the sensor response for further improving the determination of the state of the electronic device.

According to further an aspect, an in-call state of the electronic device is used in combination with the ultrasonic response signal and/or the second sensor response signal to further determine a use case of the electronic device. For example, the touchscreen response indicating a cheek response in combination with the in-call state may be sufficient to determine that state of the electronic device. In such case, for example, the second ultrasonic signal may be transmitted with a substantially reduced power as compared to the ultrasonic signal, or the second ultrasonic signal may be switched off altogether, or a transmission of the second ultrasonic signal postponed until the touchscreen response and/or the IMU response changes.

In some cases, the ultrasonic transmitter is configured to transmit an audio, or audible signal, the ultrasonic receiver is configured to receive an audio response signal, the processor is configured to determine an audio response by processing the audio response signal, wherein, in response to the audio response meeting an audio criterion, the processor is configured to adapt the power level of the second ultrasonic signal. As it will be appreciated, in certain cases, the ultrasonic touchless interface may be disabled, by preventing the transmission and/or processing of the second ultrasonic signal by replacing such detection using the audio signal. It will be appreciated that in certain cases where an audio is being played by the transmitter or loudspeaker, a response of said audio signal may be analyzed by the processor for touchless interaction, such as proximity detection. Such an implementation can be beneficial for further saving power and is considered novel and inventive in its own right.

According to yet another aspect, the sampling rate of the receiver is configured via the processor in response to the ultrasonic response meeting the first criterion, and the sensor response meeting the second criterion. As will be appreciated, further power savings can be achieved. The sampling rate may be configured in addition to configuring the power level of the second ultrasonic signal, or it may be configured independently of the second ultrasonic signal.

According to yet another aspect of any of the above teachings, the ultrasonic response signal and/or the audio response signal is used for measuring a distance of the nearest object to the electronic device, and the power of the second ultrasonic signal is configured is relationship to the distance of the nearest object. It will be appreciated that the power of the second ultrasonic signal may be decreased as the distance between the electronic device and the nearest object decreases. Similarly, the power of the second ultrasonic signal may be increased as the distance between the electronic device and the nearest object increases.

According to yet another aspect of any of the above perspectives, in cases where the sensor response satisfies at least one of the criteria from the plurality of second criteria, a transmission of the second ultrasonic signal is prevented. It will be appreciated that by doing this, the state of the electronic device is detected, such that an ultrasonic transmission from the ultrasonic transmitter, and/or processing of any ultrasonic response signal, may be prevented in those states where it is not required. Later on, when a subsequent sensor response indicates that the touchless interaction interface is required, the second ultrasonic signal is transmitted, and the processing of the associated ultrasonic response signal is enabled.

According to another aspect, the ultrasonic receiver is configured to perform ambient noise measurements. In some cases, the processor may suspend the transmission and/or processing of the second ultrasonic signal based upon the noise measurements. If the ambient noise is above a noise threshold, the second ultrasonic signal and/or a processing thereof is suspended until the ambient noise subsides below a operative noise threshold. The operative noise threshold may be the same value as the noise threshold or they may be unequal values. The threshold values may either be static, or they may be dynamic. Furthermore, the threshold values may be dependent upon the state or use case of the electronic device. As it will be appreciated, in an extremely noisy environment, where the ultrasonic signal-to-noise-ration (“SNR”) is too low to process a usable ultrasonic response signals, power may be saved by suspending the ultrasonic touchless interface. Accordingly, the processor may be configured to listen for ambient noise and resume normal ultrasonic operation when the noise is sufficiently reduced.

According to yet another aspect, the second sensor is the power button of the electronic device. Accordingly, the second ultrasonic signal is disabled or transmitted with a lower power as compared to the ultrasonic signal in response to the user pressing the power button for disabling the screen of the device. According to another aspect, in addition or alternatively, the second ultrasonic signal is enabled or transmitted at a higher power in response to the user pressing the power button to wake up the screen of the device.

In a very general sense, it will be appreciated that according to the present teachings, when one or more other sensor(s) related to the electronic device determines that an object is close to the device, the ultrasonic touchless interface or ultrasonic sensing function may be set to operate in a low-power mode. The low-power mode means that the sensing function is done at a reduced power or it may be switched off entirely. A low-power mode may include: operating with a low duty cycle, or operating with a lower transmit amplitude, or lowering the processor clock, or any combination thereof.

It will be appreciated that the ultrasonic touchless interface may use either a continuous transmission mode, or a duty-cycled transmission mode. In the continuous transmission mode, the device continuously sends a waveform with the ultrasonic transmitter, listens for echoes on the ultrasonic receiver, and processes the data including the ultrasonic response signal on the processor. In the duty-cycled transmission mode, the device is configured to transmit an ultrasonic waveform for a predetermined period of time, followed by a predetermined period of silence. During the period of period of silence, the device may not require the ultrasonic transmitter, the ultrasonic receiver, nor the processor, to be active. In some cases, it may be possible for all three components to be turned off, and to be woken up only at the end of the period of silence. As a result, by extending the periods of silence, it may be possible to reduce the amount of power required to perform the ultrasonic sensing function. It will be understood that when the period of silence is long, the ultrasonic sensing function is said to be in a low (or small) duty cycle. When the period of silence is short, the ultrasonic function is said to be in a high (or large) duty cycle.

In addition to reducing power consumption, according to another aspect, extending the periods of silence may also allow the ultrasonic sensing function to be used to analyze the environment, and for example detect another device using a similar ultrasonic sensing function in the vicinity. This detection of another device may be used to transmit the ultrasound waveform in a different frequency band

A drawback to extending the periods of silence can be that there may be a delay between the time the object may have moved, and the time at which the ultrasonic sensing function is able to detect the motion of the object. Therefore, the periods of silence may be set to a duration suited for the ultrasonic touchless interface's application or use case. For example, when an electronic device such as a phone approaches an ear, the applicant has realized that it the screen should be turned off within ca. 50 ms of coming within 1 inch (25 mm) of the ear, in order to prevent false touches. When moving the phone away from the screen, it may be acceptable for there to be a delay of 500 ms for the screen to turn back on, since it can take that much time for the user to move the phone to within their own field of view. In order to achieve a 50 ms latency limit, the duty cycle duration must be lower than the difference between 50 ms and the time it takes for the ultrasonic sensing function to determine how close the object is. It will hence be appreciated from this example that it can be beneficial to change the duty cycle depending on the position of the device and/or the state it is in at a given time.

According to yet another aspect, the processor includes a machine learning module. Accordingly, the sensor signal and/or the ultrasonic response signal are analyzed using the machine learning model such that overall power consumption is optimized according to detection of the state of the electronic

The processor is a computer or data processor such as a microprocessor or microcontroller. The processor may be a combination of different hardware components or modules. In some cases, the processor may essentially be a virtual machine running on a computer processor. The ultrasonic response signal and the sensor response signal may be processed by the same processor or by different processors. The processor may further include an artificial intelligence (“AI”) module.

The electronic device may be any device, mobile or stationary. Accordingly, devices such as mobile phones, tablets, voice assistants, smart speakers, notebook computers, desktop computers, fitness trackers, watches and similar devices fall within the ambit of the term electronic device.

In some cases, the method may involve the processor selecting certain ultrasonic transmitter/receiver combinations that can provide a spatial resolution that is improved at least in a certain area of the field of view of the ultrasonic sensor.

Viewed from yet another perspective, the present teachings can also provide an electronic device configured to implement the embodiments or any of the method steps herein disclosed.

Viewed from yet another perspective, the present teachings can also provide a computer software product for implementing any relevant method steps disclosed herein. Accordingly, the present teachings also relate to a computer readable program code having specific capabilities for executing any relevant method steps herein disclosed. In other words, the present teachings relate also to a non-transitory computer readable medium storing a program causing an electronic device to execute any relevant method steps herein disclosed.

Example embodiments are described hereinafter with reference to the accompanying drawings. Drawings may not necessarily be drawn to scale, without that affecting the scope of generality of the present teachings.

### BRIEF DESCRIPTION OF DRAWINGS

FIG. 1 shows a perspective front view of an electronic device, shown as a mobile phone, comprising a touchless interaction system

FIG. 2 shows a perspective side view of the phone showing the field of view of the sensor

FIG. 3 shows a flow-chart according to the present teachings

FIG. 4 shows another flow-chart according to the present teachings

### DETAILED DESCRIPTION

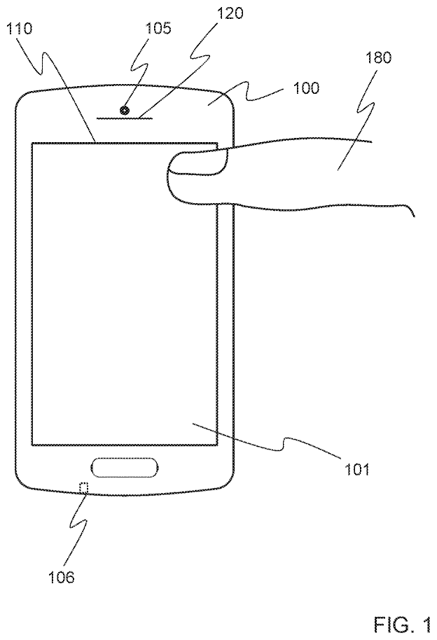

FIG. 1 shows a perspective front view of an electronic device 100 that is shown as a mobile phone. The mobile phone 100 has a screen 101 for displaying and interacting with the device 100 through a touch-based interface. Above the top-edge 110 of the screen 101, an earpiece 120 and a proximity sensor 105 are placed. As will be understood, the earpiece 120 comprises a speaker that is used for outputting acoustic signals such as audio of the caller. In certain phones, the same speaker 120 may also be used for outputting ultrasonic signals, for example for ultrasound-based user interaction. The phone 100 also comprises a microphone 106. The same microphone 106 may also be used for receiving ultrasonic signals.

The screen 101 comprises not only a display for displaying pictures and videos, but also a touchscreen sensor for touch-based user interaction. The proximity sensor 105 in many cases is an infrared (“IR”) detection based sensor, but it can also be replaced by an acoustic sensor, such as an ultrasonic sensor. Alternatively, or in addition, as discussed above, the earpiece 120 and the microphone 106 can also function as a touchless interaction system also capable of detecting proximity of an object such as a finger 180 of a user. The FIG. 1 also shows the finger 180 of a user interacting with the device 100.

In further discussion, when using the term ultrasonic sensor 105, it should be understood to include any of the cases: when the ultrasonic sensor 105 is the only sensor in the touchless user interface, the ultrasonic sensor 105 is one of ultrasonic sensors in the phone 100, or even that the ultrasonic sensor 105 is a combination of the speaker 120 and the microphone 106.

The ultrasonic sensor 105 can detect the occurrence of a near event, which corresponds to a condition when an object comes within a certain predetermined distance of the ultrasonic sensor 105 within its field of view (“FoV”). The FoV of the ultrasonic sensor 105 is a three-dimensional envelope or space around the sensor 105 within which the sensor 105 can reliably detect a proximity event, e.g., the presence of an object. Detection of a near event is used, for example, to be able to switch off the touchscreen and display (or screen 101) of the device 100 such that undesired touchscreen operation may be prevented. When the object moves outside a designated distance away from the sensor 105, the sensor 105 detects a far event.

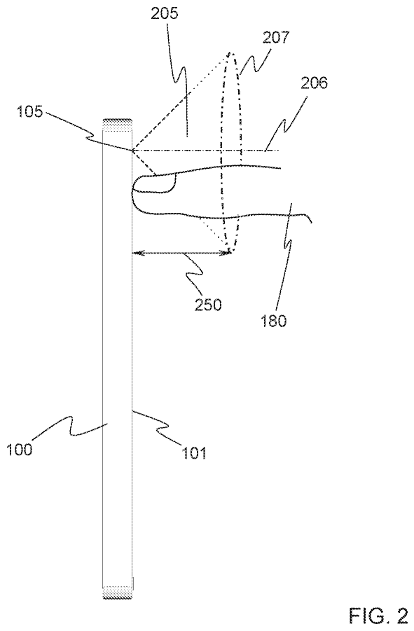

FIG. 2 shows a perspective side-view of the phone 100. The FoV 205 of the proximity sensing system is shown extending in a divergent manner from the proximity sensor 105 along an axis 206 such that the cross-sectional area of the FoV 205 in a plane normal to the axis 206 increases with distance from the proximity sensor 105 along the axis 206. Usually the FoV 205 will extend to a certain distance 250 from the sensor 105. Accordingly, FoV 205 is the region or 3D space within which the proximity sensing system can reliably detect the proximity of an object. In this example, the FoV 205 is shown as a conical shape with its vertex at the location of the proximity sensor 105 and the base 207 of the cone representing the limit within which a reliable sensing is possible. Alternatively, the base 207 of the cone could represent the limit within which proximity sensing is desired. The conical shape of the FoV 205 is shown just as an example. In some cases, the FoV 205 may be asymmetrical in either or all directions and may have another shape depending upon the sensor used. A skilled person will recognize, a certain shape of the FoV is not limiting to the generality of the present teachings.

FIG. 2 further shows the user interacting with the device 100 using his/her fingertip 108. A part of the finger 180 is lying within the FoV 205 such that a near event is detected.

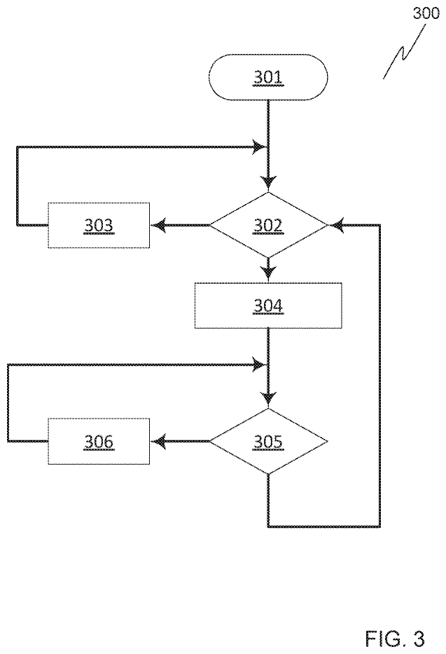

FIG. 3 shows a flow-chart 300 depicting main steps of the present teachings. At start 301, from the ultrasonic response of the sensor 105 it is analyzed 302 to check whether the ultrasonic response comprises an echo from an object such as the user's finger 108, and whether the echo represents a near event. As it will be appreciated from the preceding discussions, the ultrasonic response is obtained by processing the ultrasonic response signal received by the sensor. The ultrasonic response signal is received via the ultrasonic receiver after transmitting the ultrasonic signal through the ultrasound transmitter.

If the echo does not represent, or trigger, a near event, the transmission of the second ultrasonic signal, i.e., the subsequent ultrasonic signal to be transmitted, is either maintained at the same power level as that of the ultrasonic signal, or it is increased as compared to the ultrasonic signal. This is represented in step 303. The power level of the second ultrasonic signal can be maintained, e.g., if the transmitter is already transmitting at peak power, or if the processor determines that an increase in power is not required. Alternatively, 304, if the echo triggers a near event, the power of the second ultrasonic signal is reduced.

It will be appreciated, that the power may be manipulated (increased or decreased), by changing the amplitude of the subsequent signal, and/or, the duty cycle, and/or frequency, and/or by altering the frequency content of the second ultrasonic signal. Amplitude adjustment may sometimes be preferred as it may be simpler to realize.

In further steps, that are optional, the touchless interaction system may be made to automatically find a power level capable to detecting an object.

While transmission at reduced power it is further analyzed 305 as to whether the response to the second ultrasonic signal comprises a second echo from an object. If no echo is detected, the power level of a further ultrasonic signal, i.e., the signal to be transmitted subsequent to the second ultrasonic signal is increased 306. As it will be appreciated from the steps 305 and 306, the power of the signals to be transmitted is increased until an object us found. This can be helpful in cases when an object is expected to be close to the device and it is desired to optimize the transmission.

In case, further analysis 305 shows presence of the second echo, near analysis 302 is performed to check if the second echo is near.

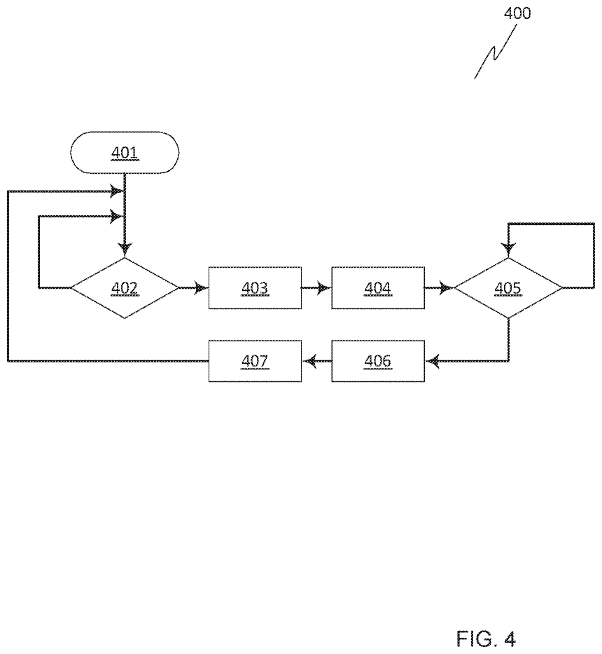

FIG. 4 illustrates another flow-chart 400 showing the main method steps for how ultrasonic sensing function may be switched-off altogether in cases where the second sensor can detect at least the far state of the electronic device. Upon start 401, it is evaluated 402 by the processor whether an object is near or if the electronic device is already in a near state. The evaluation 402 may be done by processing the ultrasonic response signal. Alternatively, or in addition, the evaluation 402 may even be done by processing one or more signals from other sensors related to the electronic device. If a near state is not detected, the second ultrasonic signal is transmitted and the evaluation 402 is performed on response obtained upon transmitting the second ultrasonic signal.

If the ultrasonic response indicates a near state, the processor proceeds to 403 and switches off the ultrasonic sensing function or ultrasonic touchless interface, i.e., prevents the second ultrasonic signal from being transmitted. The processor then, in 404, determines the sensor response by processing the second signal. As was discussed previously, the second signal is generated by the second sensor, which can be any other sensor related to the electronic device. By processing the sensor response, the processor determines 405 whether the device has entered a far state. The second signal may be obtained either by processing an existing second signal, or the processor may switch-on the sensor to obtain the second signal.

If a far state is not detected, the processor may either decide to keep the sensor enabled to continuously or periodically analyze 405 for detection of a far state, or the processor may switch-off the sensor and request an another response signal from the sensor at a later state by re-enabling the sensor.

If a far state is detected by analyzing 405 the second signal, the processor may optionally 406 switch off the second sensor, and 407 switch on or re-enable the ultrasonic sensing function or ultrasonic touchless interface. Accordingly, the second ultrasonic signal is transmitted and the near state is analyzed 402 from the response obtained after transmitting the second ultrasonic signal.

With reference to any of the aspects of the present teachings, further power savings may be achieved by lowering the processor speed, though in some cases it may introduce a delay in the time it takes to process the ultrasound response signal from the receiver.

When transmitting ultrasonic signals at maximum power or amplitude, the ultrasonic interface is able to detect echoes at greater distances, and usually with greater accuracy. When transmitting ultrasonic signals at a reduced power or amplitude, the ultrasonic interface is able to detect echoes at reduced distances, and usually with reduced accuracy, but also with reduced power consumption.

The decision to increase or decrease the duty cycle, and to increase or decrease the ultrasonic power, can be made using one or more of 1) the ultrasonic sensing function itself, and 2) other sensing functions present on the device.

According to an aspect, the decision to increase or decrease the ultrasonic signal amplitude is made using the ultrasonic sensing function itself. When the object (which may be a user's head, or hand, or body) is known to be close to the device. The applicant has realized that there is no need for the ultrasonic interface to detect objects at a distance that is greater than the distance to the object. Hence, when the distance to the object has been successfully measured by the ultrasonic sensing interface, it may be suitable to reduce the power or amplitude of the ultrasonic transmitter's signal.

According to another aspect, the decision to (a) decrease the ultrasound amplitude, or to (b) lower the duty cycle, or to (c) both decrease the ultrasound amplitude and lower the duty cycle, is made by interpreting information provided by sensors other than the ultrasonic sensing function. The other sensors may include one or more of 1) a capacitive sensor such as touchscreen 2) an infrared proximity sensor or an infrared time-of-flight (TOF) sensor, 3) an inertial measurement unit (IMU), or 4) any sensor capable of estimating the proximity of, or the distance to, another object, directly or indirectly. An example of an indirect method of sensing is the IMU, which can determine if a device is placed on a table or still surface, only based on the lack of device's acceleration or angular motion.

In the situation where a capacitive sensor is used, the proximity of the user's head, including the ear and/or the cheek, may be determined. When the capacitive sensor determines that the user's head is near with a high degree of certainty, it is not necessary to use the ultrasonic sensing function, and the ultrasonic signal transmission can be turned off. When the capacitive sensor determines that the user's head is near with a low degree of certainty, the ultrasonic sensing function may be maintained, but at either a lower transmission amplitude, or a lower duty cycle, or both. This allows the ultrasonic sensing function to disambiguate cases where the capacitive sensor mistakenly assesses the user's head to be near, when the capacitive signal comes from the user's hand or other sources.

In the situation where an infrared sensor (either an infrared proximity sensor or an infrared TOF sensor) is used, the proximity of the user's head, including the ear and/or the cheek, may be determined. When the infrared sensor determines that the user's head is near, it is not necessary to use the ultrasonic sensing function, and the ultrasonic signal transmission may be turned off. In some cases, the infrared sensor is only turned on when the user's head has already been determined to be near, by means of the ultrasonic sensing function or a combination of the ultrasonic sensing function and other sensors. In these implementations, the infrared sensor is only used to detect that the head is head is no longer near the device, and instruct other sensors to determine when the head is near the device again.

In the situation where an IMU is used, the IMU is able to detect if the device is in a stationary state, or in a dynamic state. When the device is in a stationary state, it may not be necessary for the ultrasonic sensing function or ultrasonic touchless interface to operate with a low duty cycle, because it is unlikely that the distance between the device and the user is changing rapidly. Example of stationary states include when the user holds the phone against the ear and remains relatively motionless for an extended period of time. In other stationary states, such as when the phone is deemed to be placed on a table, the ultrasonic sensing function may be turned off. When the device is in a dynamic state, the ultrasonic sensing function may need to operate in a high duty cycle in order to detect changes. Since the IMU operates at a high duty cycle, reporting events at least 20 times per second, it can turn on the ultrasonic sensing function rapidly enough to detect sudden user motions.

Various embodiments have been described above for a method for proximity detection on an electronic device, an electronic device comprising such a proximity detection system or measurement system, and a software product for executing proximity detection steps for the same. Those skilled in the art will understand, however that changes and modifications may be made to those examples without departing from the spirit and scope of the following claims and their equivalents. It will further be appreciated that aspects from the method and product embodiments discussed herein may be freely combined.

Certain embodiments of the present teachings are summarized in the following clauses.

### Clause 1.

A method for determining the proximity of an object to an electronic device, the electronic device comprising an ultrasonic sensor and a second sensor, which ultrasonic sensor comprising at least one ultrasonic transmitter and at least one ultrasonic receiver, which method comprising the steps of:
transmitting from the ultrasonic transmitter an ultrasonic signal;
receiving at the ultrasonic receiver an ultrasonic response signal;
determining an ultrasonic response by processing the ultrasonic response signal using a processor;
determining a sensor response by processing a second signal using a processor, said second signal being generated by the second sensor;
configuring via the processor a power level of a second ultrasonic signal transmitted from the ultrasonic transmitter in response to the ultrasonic response meeting a first criterion, and the sensor response meeting a second criterion.

### Clause 2.

The method according to clause 1, wherein the first criterion is chosen from a plurality of first criteria.

### Clause 3.

The method according to any of the preceding clauses, wherein the second criterion is chosen from a plurality of second criteria.

### Clause 4.

The method according to any of the preceding clauses, wherein the first criterion is a threshold value and/or a pattern associated with the ultrasonic response or the ultrasonic response signal.

### Clause 5.

The method according to any of the preceding clauses, wherein the second criterion is a threshold value and/or a pattern associated with the sensor response or the second signal.

### Clause 6.

The method according to any of the preceding clauses, wherein the first criterion overrides the second criterion such that the power level of the second ultrasonic signal is configured in response to the ultrasonic response meeting the first criterion.

### Clause 7.

The method according to any of the preceding clauses 1-5, wherein the second criterion overrides the first criterion such that the power level of the second ultrasonic signal is configured in response to the sensor response meeting the second criterion.

### Clause 8.

The method according to any of the preceding clauses, wherein the second sensor comprises a capacitive sensor, e.g., a touchscreen sensor.

### Clause 9.

The method according to any of the preceding clauses, wherein the second sensor comprises an accelerometer.

### Clause 10.

The method according to any of the preceding clauses, wherein the second sensor comprises a magnetic sensor.

### Clause 11.

The method according to any of the preceding clauses, wherein the second sensor comprises a light sensor.

### Clause 12.

The method according to any of the preceding clauses, wherein the second sensor comprises a gyroscopic sensor.

### Clause 13.

The method according to any of the preceding clauses, wherein the power of the second ultrasonic signal is configured by altering the amplitude of the second ultrasonic signal with respect to the amplitude of the ultrasonic signal.

### Clause 14.

The method according to any of the preceding clauses, wherein the power of the second ultrasonic signal is configured by changing the frequency of the second ultrasonic signal with respect to the frequency of the ultrasonic signal.

### Clause 15.

The method according to any of the preceding clauses, wherein the power of the second ultrasonic signal is configured by changing the frequency content of the second ultrasonic signal with respect to the frequency content of the ultrasonic signal.

### Clause 16.

The method according to any of the preceding clauses, wherein the power of the second ultrasonic signal is configured by changing the duty-cycle of the second ultrasonic signal with respect to the duty-cycle of the ultrasonic signal.

### Clause 17.

The method according to any of the preceding clauses, wherein at least the first criterion or the second criterion is a near state of the electronic device.

### Clause 18.

An electronic device comprising an ultrasonic sensor and a second sensor, which ultrasonic sensor comprising at least one ultrasonic transmitter and at least one ultrasonic receiver, wherein the electronic device is configured to:
transmit an ultrasonic signal from the ultrasonic transmitter;
receive an ultrasonic response signal at the ultrasonic receiver;
determine via a processor an ultrasonic response by processing the ultrasonic response signal; and
determine via the processor a sensor response by processing a second signal generated by the second sensor; wherein
   the electronic device is configured to adapt a power level of a second ultrasonic signal transmitted from the ultrasonic transmitter in response to the ultrasonic response meeting a first criterion, and the sensor response meeting a second criterion.

### Clause 19.

A computer software product, and a carrier bearing the same, which, when executed on a processing means, causes the processing means to:
transmit an ultrasonic signal from an ultrasonic transmitter;
receive an ultrasonic response signal at an ultrasonic receiver;
determine via a processor an ultrasonic response by processing the ultrasonic response signal; and
determine via the processor a sensor response by processing a second signal generated by the second sensor; and
configure a power level of a second ultrasonic signal transmitted from the ultrasonic transmitter in response to the ultrasonic response meeting a first criterion, and the sensor response meeting a second criterion.

### Clause 20.

An electronic device configured to perform the steps of any of the clauses 1-17.

### Clause 21.

A computer readable program code having specific capabilities for executing the steps of any of the clauses 1-17.

1. A method for determining the proximity of an object to an electronic device, the electronic device comprising a first ultrasonic sensor and a second sensor, which ultrasonic sensor comprising at least one ultrasonic transmitter and at least one ultrasonic receiver, the method comprising:
transmitting from the ultrasonic transmitter a first ultrasonic signal;
receiving at the ultrasonic receiver an ultrasonic response signal;
determining an ultrasonic response by processing the ultrasonic response signal using a processor;
determining a sensor response by processing a second signal using the processor, the second signal being generated by the second sensor;
configuring via the processor a power level of a second ultrasonic signal transmitted from the ultrasonic transmitter in response to the ultrasonic response meeting a first criterion, and the sensor response meeting a second criterion.

2. The method according to claim 1, wherein the first criterion is chosen from a plurality of first criteria.

3. The method according to claim 1, wherein the second criterion is chosen from a plurality of second criteria.

4. The method according to claim 1, wherein the first criterion is a threshold value and/or a pattern associated with the ultrasonic response or the ultrasonic response signal.

5. The method according to claim 1, wherein the second criterion is a threshold value and/or a pattern associated with the sensor response or the second signal.

6. The method according to claim 1, wherein the first criterion overrides the second criterion such that the power level of the second ultrasonic signal is configured in response to the ultrasonic response meeting the first criterion.

7. The method according to claim 1, wherein the second criterion overrides the first criterion such that the power level of the second ultrasonic signal is configured in response to the sensor response meeting the second criterion.

8. The method according to claim 1, wherein the second sensor comprises a capacitive sensor.

9. The method according to claim 1, wherein the second sensor comprises an accelerometer.

10. The method according to claim 1, wherein the second sensor comprises a magnetic sensor.

11. The method according to claim 1, wherein the second sensor comprises a light sensor.

12. The method according to claim 1, wherein the second sensor comprises a gyroscopic sensor.

13. The method according to claim 1, wherein the power of the second ultrasonic signal is configured by altering the amplitude of the second ultrasonic signal with respect to the amplitude of the ultrasonic signal.

14. The method according to claim 1, wherein the power of the second ultrasonic signal is configured by changing the frequency of the second ultrasonic signal with respect to the frequency of the ultrasonic signal.

15. The method according to claim 1, wherein the power of the second ultrasonic signal is configured by changing the frequency content of the second ultrasonic signal with respect to the frequency content of the ultrasonic signal.

16. The method according to claim 1, wherein the power of the second ultrasonic signal is configured by changing the duty-cycle of the second ultrasonic signal with respect to the duty-cycle of the ultrasonic signal.

17. The method according to claim 1, wherein at least the first criterion or the second criterion is a near state of the electronic device.

18. An electronic device comprising a first ultrasonic sensor and a second sensor, which ultrasonic sensor comprising at least one ultrasonic transmitter and at least one ultrasonic receiver, wherein the electronic device is configured to:
transmit an ultrasonic signal from the ultrasonic transmitter;
receive an ultrasonic response signal at the ultrasonic receiver;
determine via a processor an ultrasonic response by processing the ultrasonic response signal;
determine via the processor a sensor response by processing a second signal generated by the second sensor; and
wherein the electronic device is configured to adapt a power level of a second ultrasonic signal transmitted from the ultrasonic transmitter in response to the ultrasonic response meeting a first criterion, and the sensor response meeting a second criterion.

19. A computer software product and a carrier bearing the same, which, when executed on a processor, causes the processor to:
transmit an ultrasonic signal from an ultrasonic transmitter;
receive an ultrasonic response signal at an ultrasonic receiver;
determine via a processor an ultrasonic response by processing the ultrasonic response signal;
determine via the processor a sensor response by processing a second signal generated by the second sensor; and
configure a power level of a second ultrasonic signal transmitted from the ultrasonic transmitter in response to the ultrasonic response meeting a first criterion, and the sensor response meeting a second criterion.

20. An electronic device configured to perform the steps of claim 1.

21. A computer readable program code having specific capabilities for executing the steps of claim 1.
